(19) United States
(12) Patent Application Publication
(10) Pub. No.: US 2025/0109049 A1
(43) Pub. Date: Apr. 3, 2025

(54) WATER TREATMENT METHOD AND WATER TREATMENT APPARATUS

(71) Applicant: ORGANO CORPORATION, Tokyo (JP)

(72) Inventors: Yudai SUZUKI, Tokyo (JP); Yasuhide TAKUMA, Tokyo (JP); Hiro YOSHIKAWA, Tokyo (JP); Chiharu ARAKI, Tokyo (JP)

(73) Assignee: ORGANO CORPORATION, Tokyo (JP)

(21) Appl. No.: 18/833,432

(22) PCT Filed: Jan. 25, 2023
(86) PCT No.: PCT/JP2023/002287

§ 371 Date: Jul. 26, 2024

(30) Foreign Application Priority Data
Feb. 1, 2022 (JP) 2022-014162

(51) Int. Cl. C02F 1/44; C02F 1/50

(52) U.S. Cl. CPC C02F 1/441; C02F 1/50; C02F 2209/02; C02F 2209/03; C02F 2209/44

(57) ABSTRACT

A water treatment method includes: supplying water to be treated to a reverse osmosis membrane to be separated into permeate water and concentrate water; and intermittently adding a biocide to water to be treated that is to supplied to the reverse osmosis membrane, the biocide being a bromine-based oxidant, a stabilized hypobromous acid composition containing bromine and a sulfamic acid compound, an iodine-based oxidant, or 2,2-dibromo-3-nitrilopropionamide (DBNPA), wherein the intermittently adding the biocide includes: evaluating a degree of biological contamination of the reverse osmosis membrane; and adjusting, based on the evaluated degree of biological contamination, an amount of the biocide to be added to the water to be treated per a predetermined period to an extent that an oxidation-reduction potential and/or total chlorine concentration of the water to be treated after adding the biocide does not exceed a preset predetermined value.

### TECHNICAL FIELD

This invention relates to a water treatment method and a water treatment apparatus.

### BACKGROUND ART

A known water treatment apparatus for removing impurities from water to be treated is one including a reverse osmosis (RO) membrane. In this apparatus, water to be treated (e.g. raw water), that is supplied to the RO membrane at a predetermined supply pressure, is separated into permeate water and concentrate water by the RO membrane. Thus, treated water from which impurities have been removed (i.e. permeate water) can be obtained.

The water treatment apparatus with RO membrane is required to continue stable operation, and for this purpose, it is important to control biofouling, which is the accumulation of organisms in raw water on the RO membrane surface. As a countermeasure against such biofouling, an addition of biocide that inhibits the growth of organisms to raw water has conventionally been used, and a known typical biocide is an oxidant, such as hypochlorous acid, hypobromous acid, or a stabilized composition thereof (see, for example, Patent Literature 1). On the other hand, cost reduction requirements and increased environmental awareness have recently led to the need for effective control of biofouling while minimizing the amount of biocide used. For example, Patent Literature 2 proposes a method in which the amount of biocide to be added is adjusted according to the degree of biofouling.

### CITATION LIST

### Patent Literature

Patent Literature 1: JP 6401491 B
Patent Literature 2: WO 2020/158645 A1

### SUMMARY OF THE INVENTION

### Technical Problem

However, the method disclosed in Patent Literature 2 does not consider at all the influence of biocide on the RO membrane, especially when an oxidant as disclosed in Patent Literature 1 is used.

It is therefore an object of the present invention to provide a water treatment method and a water treatment apparatus that prevent blockage of the reverse osmosis membrane caused by biofouling and achieve stable water treatment performance.

### Solution to Problem

To achieve the above object, a water treatment method of the present invention includes: supplying water to be treated to a reverse osmosis membrane to be separated into permeate water and concentrate water; and intermittently adding a biocide to water to be treated that is to supplied to the reverse osmosis membrane, the biocide being a bromine-based oxidant, a stabilized hypobromous acid composition containing bromine and a sulfamic acid compound, an iodine-based oxidant, or 2,2-dibromo-3-nitropropionamide (DBNPA), wherein the intermittently adding the biocide includes: evaluating a degree of biological contamination of the reverse osmosis membrane; and adjusting, based on the evaluated degree of biological contamination, an amount of the biocide to be added to the water to be treated per a predetermined period to an extent that an oxidation-reduction potential and/or total chlorine concentration of the water to be treated after adding the biocide does not exceed a preset predetermined value.

In addition, a water treatment device of the present invention includes: a reverse osmosis membrane device that separates water to be treated into permeate water and concentrate water; a biocide addition device that adds a biocide to water to be treated that is to be supplied to the reverse osmosis membrane device, the biocide being a bromine-based oxidant, a stabilized hypobromous acid composition containing bromine and a sulfamic acid compound, an iodine-based oxidant, or 2,2-dibromo-3-nitropropionamide (DBNPA); and a control device that intermittently performs an addition of the biocide by the biocide addition device, wherein the control device evaluates a degree of biological contamination of the reverse osmosis device, and adjusts, based on the evaluated degree of biological contamination, an amount of the biocide to be added to the water to be treated per a predetermined period to an extent that an oxidation-reduction potential and/or total chlorine concentration of the water to be treated after adding the biocide does not exceed a preset predetermined value.

According to the water treatment method and the water treatment apparatus, the biocide can be added to the water to be treated (e.g. raw water) without excess or deficiency according to the degree of biological contamination (i.e. biofouling) to the extent that the oxidizing power of the biocide does not adversely affect the reverse osmosis membrane.

### Advantageous Effects of Invention

As described above, according to the present invention, the blockage of the reverse osmosis membrane caused by biofouling can be prevented and stable water treatment performance can be achieved.

### BRIEF DESCRIPTION OF THE DRAWINGS

FIG. 1 is a schematic diagram of a water treatment apparatus according to an embodiment of the present invention;

FIG. 2 is a graph showing how a raw water pressure and the duration of biocide addition per 24 hours change over time in Example 1;

FIG. 3 is a graph showing how the raw water pressure and the biocide concentration in raw water change over time in Comparative Example 1;

FIG. 4 is a graph showing how the raw water pressure changes over time in Comparative Example 2; and

FIG. 5 is a graph showing how the duration of biocide addition per 12 hours changes over time in Examples 2 and 3.

### DESCRIPTION OF EMBODIMENTS

An embodiment of the present invention will be described below with reference to the drawings.

Water treatment apparatus 10 of this embodiment includes raw water tank 11 and reverse osmosis (RO) membrane device 12, wherein raw water (i.e. water to be treated) stored in raw water tank 11 is treated by RO membrane device 12 so that impurities contained in the raw water are removed to produce treated water. RO membrane device 12 is used to separate raw water supplied from raw water tank 11 into concentrate water containing impurities and permeate water from which impurities are removed, and includes an RO membrane. RO membrane device 12 is connected to water supply line L1 for supply of raw water from raw water tank 11 to RO membrane device 12, permeate water line L2 for supply of permeate water flowing out of RO membrane device 12 to a treated water tank or a point of use, and drainage line L3 for drainage of concentrate water flowing out of RO membrane device 12 to the outside. Raw water tank 11 is connected to raw water line L4 for supply of raw water, that has been subjected to pretreatments such as turbidity removal and dechlorination by a pretreatment system (not shown), to raw water tank 11.

Water treatment apparatus 10 also includes pressurizing pump 13 installed in water supply line L1, raw-water pressure sensor 14 and temperature sensor 15 that are also installed in water supply line L1, and concentrate-water pressure sensor 16 and manual valve V1 that are installed in drainage line L3. Pressurizing pump 13 is designed to have its rotational speed controlled by an inverter (not shown) and functions to adjust the supply pressure of raw water supplied to RO membrane device 12 through water supply line L1 (called “raw water pressure”). Raw-water pressure sensor 14 functions to detect the raw water pressure. Temperature sensor 15 functions to detect the temperature of raw water supplied to RO membrane device 12 (called “raw water temperature”). Temperature sensor 15 may be arranged to detect the water temperature of either permeate water or concentrate water flowing out of RO membrane device 12, i.e., it may be installed in permeate water line L2 or drainage line L3. Concentrate-water pressure sensor 16 functions, together with raw-water pressure sensor 14, to detect the differential pressure of the RO membrane (i.e. the difference between the supply pressure of raw water supplied to the RO membrane and the outflow pressure of concentrate water flowing out of the RO membrane). Manual valve V1 functions as a flow controller to adjust the flow rate of concentrate water flowing through drainage line L3. As described below, temperature sensor 15 may be omitted if concentrate-water pressure sensor 16 is provided.

During operation of water treatment apparatus 10, raw water stored in raw water tank 11 is supplied to RO membrane device 12 by operation of pressurizing pump 13, and then treated to be separated into permeate water and concentrate water. Permeate water is supplied to the treated water tank or the point of use through permeate water line L2, and concentrate water is drained to the outside through drainage line L3. On the other hand, raw water tank 11 is continuously supplied with raw water, that has been subjected to pretreatments such as turbidity removal and dechlorination by the pretreatment system (not shown), through raw water line L4 in accordance with the flow rate of raw water supplied to RO membrane device 12. Raw water tank 11 does not necessarily need to be provided for the function of water treatment apparatus 10, but is preferably provided from the viewpoint of adding a biocide to raw water, as described below.

Water treatment apparatus 10 also includes biocide addition device 20 for adding a biocide that inhibits RO membrane biofouling to raw water supplied to RO membrane device 12, and control device 30 for controlling the operation of the water treatment apparatus 10, including the addition of biocide by biocide addition device 20.

Biocide addition device 20 includes biocide tank 21 that stores a biocide and chemical injection pump 22 connected to raw water tank 11 through biocide supply line L5 for injecting the biocide stored in biocide tank 21 into raw water tank 11. The addition of biocide by biocide addition device 20 is preferably performed intermittently as described below from the viewpoint of running costs and environmental impact, but in that case, there is concern that biofouling may progress while the addition is not being done. Therefore, the biocide to be added preferably have a higher biocide power, i.e., a higher oxidation-reduction potential (ORP), which is one indicator of biocide power. Specifically, a biocide is preferable which has an ORP greater than 500 mV when the aqueous solution is adjusted to achieve a total chlorine concentration of 10 mg/L and a pH of 7.3. Such a biocide includes, for example, a bromine-based oxidant, a stabilized hypobromous acid composition containing bromine and a sulfamic acid compound, an iodine-based oxidant, or 2,2-dibromo-3-nitropropionamide (DBNPA). It should be noted that the use of chlorine-based oxidant (such as sodium hypochlorite) as a biocide is not preferable because it may cause the degradation of polyamide-based RO membranes. The location where the biocide is injected may not be at raw water tank 11, and for example, may be on water supply line L1 between pressurizing pump 13 and raw-water pressure sensor 14. In that case, however, the pressure at the injection point is higher compared to the case where it is injected into raw water tank 11, thus requiring chemical injection pump 22 having a large capacity, which is undesirable in terms of cost. Therefore, the location where the biocide is injected, or where biocide supply line L5 is connected, is preferable at raw water tank 11, as illustrated.

Control device 30 controls, during the above-described operation of water treatment apparatus 10, pressurizing pump 13 to implement flow control to maintain a constant flow rate (i.e. a predetermined set flow rate) of permeate water flowing through permeate water line L2. For example, as the water temperature changes, its viscosity changes and the flow rate of permeate water separated by the RO membrane also changes, and in response to this change, control device 30 controls the rotational speed of pressurizing pump 13 through the inverter. Specifically, as the water temperature decreases, its viscosity increases, and accordingly, the flow rate of permeate water separated by the RO membrane decreases. Therefore, to offset this decrease, control device 30 increases the rotational speed of pressurizing pump 13, thereby increasing the raw water pressure. On the other hand, as the water temperature increases, its viscosity decreases, and accordingly, the flow rate of permeate water separated by the RO membrane increases. Therefore, to offset this increase, control device 30 decreases the rotational speed of pressurizing pump 13, thereby decreasing the raw water pressure. Thus, the rotational speed of pressurizing pump 13, or the raw water pressure, is adjusted, so that the flow rate of permeate water flowing through permeate water line L2 is adjusted to the set flow rate.

During operation of water treatment apparatus 10, the flow rate of concentrate water flowing through drainage line L3 is preferably adjusted, in parallel with the above-described flow control of permeate water, to control scaling, which is the deposition of impurities (especially silica or calcium) on the RO membrane surface. Specifically, it is desired to set a target recovery ratio (i.e. target ratio of the flow rate of concentrate water to the sum of the flow rate of concentrate water and the flow rate of concentrate drainage water) based on the previously measured concentration of impurities in raw water so that the concentration of impurities in concentrate water does not exceed the solubility at the previously measured water temperature, and then to adjust the flow rate of concentrate water so as to achieve the set target recovery ratio. The flow rate adjustment in this case is carried out with manual valve V1 installed in drainage line L3, and the set flow rate is determined based on the target recovery ratio and the set flow rate of permeate water.

Control device 30 also controls, during operation of water treatment apparatus 10, biocide addition device 20 to perform a biocide addition process of adding the biocide to raw water supplied to RO membrane device 12 intermittently, preferably periodically (e.g. once every 24 hours).

In the biocide addition process, the degree of RO membrane biofouling (i.e. biological contamination) at that time is first evaluated prior to the addition of biocide, specifically, a contamination level indicating the degree of biofouling is calculated based on values detected by respective sensors 14, 15, 16. The method for calculating the contamination level will be described below. Once the contamination level of the RO membrane is calculated, the amount of biocide to be added to raw water per biocide addition process is determined based on the calculated contamination level. Specifically, a value obtained by adding an amount to be added that is set according to (e.g. proportional to) the calculated contamination level to a preset minimum amount to be added is determined as a new amount to be added. Chemical injection pump 22 is then controlled based on the determined amount to be added to execute the biocide addition process, and raw water is supplied to raw water tank 11 at a predetermined flow rate corresponding to the flow rate of raw water supplied to RO membrane device 12. In other words, during the biocide addition process, the raw water containing a predetermined concentration of the biocide is supplied to RO membrane device 12. Thus, the degree of biofouling can be accurately determined and then the corresponding minimum amount of biocide can be added to raw water, which, as a result, can also reduce the running costs and environmental impact.

In the meantime, to reduce the influence of biocide, especially of oxidant, on the membrane, a low CT value (i.e. product of the biocide concentration and the contact time of the biocide with the membrane) is considered effective. Conversely, it is considered that even if the concentration or contact time of the biocide is changed, the same CT value will make little difference in the influence of biocide on the membrane. According to this, the same total amount of biocide to be added to raw water during the biocide addition process should be the same influence of biocide on the RO membrane, regardless of the biocide concentration in the raw water and the duration of biocide addition (i.e. the duration of execution of the biocide addition process). In other words, to adjust (i.e. change) the amount of biocide to be added per biocide addition process, changing the duration of biocide addition without changing the biocide concentration in the raw water or changing the biocide concentration in the raw water without changing the duration of biocide addition should make little difference in the influence of biocide on the RO membrane.

In practice, however, the inventors have verified and confirmed that when the biocide concentration in the raw water is changed without changing the duration of biocide addition, the biocide may indirectly adversely affect the RO membrane under certain conditions. Specifically, as shown in examples described below, it has been confirmed that when the biocide concentration is increased until the ORP of the raw water after adding the biocide exceeds a certain upper limit, the increase in the raw water pressure, which should be controlled, is not controlled. From the analysis of accumulated substances on the RO membrane where the raw water pressure has been increased, it can be inferred that the reason for this is that the use of a high ORP biocide caused viscous substances to be released from organisms accumulated on the RO membrane surface, and the viscous substances blocked the RO membrane.

Therefore, in this embodiment, to prevent such an increase in the raw water pressure, the biocide concentration in the raw water is unchanged from the initial set concentration, and as the degree of biofouling changes, the duration of execution of the biocide addition process, i.e. the duration of biocide addition per predetermined period equivalent to its execution cycle, is changed accordingly. Specifically, once the contamination level of the RO membrane is calculated, a value obtained by adding a duration set according to (e.g. proportional to) the calculated contamination level to a preset minimum duration of addition (i.e. a value obtained by dividing a preset minimum amount to be added by the set concentration of the biocide) is set as a new duration of addition. The set concentration of the biocide is the concentration at which the ORP of the raw water after adding the biocide does not exceed the upper limit described above, and the upper limit is preferably determined by experimentally verifying in advance the range within which the RO membrane is not blocked by viscous substances of biological origin, as shown in the examples described below. Further, the biocide concentration in the raw water can be calculated from the flow rates of raw water and biocide in a simplified manner, but is preferably obtained by manually sampling raw water flowing through water supply line L1 and measuring the total chlorine concentration in the raw water using the DPD method with a portable residual chlorine meter.

As described above, according to this embodiment, the amount of biocide to be added to the raw water per biocide addition process is adjusted to the extent that the ORP of the raw water after adding the biocide does not exceed a preset upper limit (i.e. a predetermined value). Specifically, the amount of biocide to be added is adjusted by changing the duration of biocide addition according to the degree of biofouling while maintaining a constant biocide concentration in the raw water such that the ORP of the raw water after adding the biocide does not exceed the above-described upper limit. Thus, the biocide can be added to the raw water without excess or deficiency according to the degree of biofouling to the extent that the oxidizing power of the biocide does not adversely affect the RO membrane.

The set concentration of the biocide is not particularly limited as long as the ORP of the raw water after adding the biocide does not exceed a preset upper limit, but if it is too low, the biocide may not be effective enough to achieve the desired results. Therefore, to produce the minimum disinfecting power, the set concentration of the biocide is preferably the concentration at which the ORP of the raw water after adding the biocide does not fall below a predetermined lower limit. The total chlorine concentration may be used instead of, or in addition to, the ORP as an indicator for determining the set concentration of the biocide. Further, the duration of biocide addition increases as the biofouling progresses, but an excessively long duration is undesirable from the viewpoint of running costs and environmental impact. Therefore, the duration of biocide addition is preferably adjusted so as not to exceed a preset maximum duration of addition. In other words, if the duration of addition calculated by the above-described method exceeds a preset maximum duration of addition, then the preset maximum duration of addition, not the calculated duration of addition, is preferably set as a new duration of addition. In this case, if priority is given to preventing blockage of the RO membrane rather than reducing running costs and environmental impact, the biocide may be added continuously on a temporary basis until the next biocide addition process.

Three methods for calculating the contamination level indicating the degree of RO membrane biofouling will be described here.

### (First Calculation Method)

Since the occurrence of RO membrane biofouling leads to blockage of the flow path of raw water and in turn to an increase in pressure drop, its influence appears as a change (i.e. increase) in the raw water pressure if flow control to maintain a constant flow rate of permeate water flowing through permeate water line L2 is implemented as described above. Therefore, the degree of biofouling can be accurately determined by calculating how much that increase is. However, the raw water pressure not only varies with the degree of biofouling, but also with water temperature, as described above. As such, to accurately calculate how much the raw water pressure increases due to biofouling, it is necessary to compare the current raw water pressure should not directly with the raw water pressure when starting to use the RO membrane (called “initial raw water pressure”), but with the value obtained by correcting the initial raw water pressure for the influence of water temperature fluctuations, i.e., the value obtained by converting the initial raw water pressure into a pressure at the current water temperature.

Therefore, in the first calculation method, the contamination level of the RO membrane is calculated as follows. As a precondition, control device 30 stores the initial value of the raw water pressure (called “initial raw water pressure”) previously detected by raw-water pressure sensor 14 and the initial value of the raw water temperature (called “initial raw water temperature”) previously detected by temperature sensor 15 when starting to use the RO membrane. The initial raw water pressure and temperature may be those obtained immediately after starting to use the RO membrane, but they are preferably those obtained after a certain period has elapsed since the RO membrane was first used and its performance has stabilized, or may be their moving averages. On the other hand, the initial raw water pressure and temperature are newly obtained each time the RO membrane is replaced with a new one, and are stored and updated in control device 30.

First, the current raw water pressure is detected by raw-water pressure sensor 14, and at the same time, the current raw water temperature is detected by temperature sensor 15. In practice, moving averages of the values detected by respective sensors 14, 15 are calculated and obtained (i.e. detected) as the current raw water pressure and temperature. Then, using information (such as tables and functions) on temperature correction factors previously stored in internal storage or an external server, the temperature correction factor at the detected current raw water temperature and the temperature correction factor at the initial raw water temperature previously stored in control device 30 are retrieved. The temperature correction factor is a factor used to correct the flux of RO membrane measured at a given temperature to what it would be at a standard temperature (e.g. 25° C.), and the manufacturer provides temperature correction factors for various temperatures for each type of RO membrane. The temperature correction factor at the initial raw water temperature may be previously retrieved and stored in control device 30 when starting to use the RO membrane. Once the respective temperature correction factors are retrieved, the initial raw water pressure is converted into a value at the current raw water temperature based on the retrieved temperature correction factors. Specifically, if the initial raw water pressure is represented by P₀, a converted initial pressure P_{R0}, which is obtained by converting the initial raw water pressure into a value at the current raw water temperature, is given by the following Equation (1):

$${P}_{R 0} = {P}_{0} \times ( {K}_{i} / {K}_{0} ) , \qquad ( 1 )$$

where Kᵢ is the temperature correction factor at the current raw water temperature and K₀ is the temperature correction factor at the initial raw water temperature.

The converted initial pressure calculated by Equation (1) described above is then compared with the detected current raw water pressure, and if the current raw water pressure is higher than the converted initial pressure, biofouling is determined to have occurred and the difference between them is calculated as the contamination level. On the other hand, if the current raw water pressure is equal to or lower than the converted initial pressure, the contamination level is set to zero, given that biofouling has not occurred.

### (Second Calculation Method)

The second calculation method is a method in which, to offset the influence of water temperature fluctuations on the raw water pressure, the initial raw water pressure is not converted into a pressure at the current water temperature as in the first calculation method, but rather the initial raw water pressure and the current raw water pressure are respectively converted into pressures at a standard temperature (e.g. 25° C.), and based on comparison between the converted ones, the contamination level of the RO membrane is calculated. This allows accurate calculation of how much the raw water pressure increases over time due to biofouling, i.e., the contamination level of the RO membrane, as in the first calculation method. In the second calculation method, the values detected by respective sensors 14, 15 are also used to calculate the contamination level of the RO membrane, as shown below, and it is the same as in the first calculation method that in practice their moving averages are preferably used.

In the second calculation method, as a precondition, control device 30 stores a converted initial pressure, which is obtained by converting the initial raw water pressure into a value at the standard temperature. In this case, if the initial raw water pressure is represented by P₀ and the temperature correction factor at the initial raw water temperature is represented by K₀, the converted initial pressure P_{R0}′ is given by the following Equation (2):

$${P}_{R 0}^{′} = {P}_{0} / {K}_{0} . \qquad ( 2 )$$

As with the initial raw water pressure and temperature in the first calculation method, the converted initial pressure is newly obtained each time the RO membrane is replaced with a new one, and is stored and updated in control device 30.

Then, when the current raw water pressure and temperature are respectively detected by raw-water pressure sensor 14 and temperature sensor 15, the temperature correction factor at the detected current raw water temperature is retrieved, and the current raw water pressure is converted into a value at the standard temperature based on the retrieved temperature correction factor. Specifically, if the current raw water pressure is represented by Pi and the temperature correction factor at the current raw water temperature is represented by Kᵢ, a converted raw water pressure P_{Ri}, which is obtained by converting the current raw water pressure into a value at the standard temperature, is given by the following Equation (3):

$${P}_{R i} = {P}_{i} / {K}_{i} . \qquad ( 3 )$$

The converted raw water pressure thus calculated is compared with the converted initial pressure (see Equation (2) described above) previously stored in control device 30, and if the converted raw water pressure is higher than the converted initial pressure, the difference between them is calculated as the contamination level, as in the first calculation method. On the other hand, it is also the same as in the first calculation method that the contamination level is set to zero if the converted raw water pressure is equal to or lower than the converted initial pressure.

### (Third Calculation Method)

Both calculation methods described above are methods that use the raw water pressure detected by raw-water pressure sensor 14 to calculate the contamination level of the RO membrane. These methods are effective when it is not possible to obtain the outflow pressure of concentrate water flowing out of RO membrane device 12 due to structural reasons, such as the inability to install a pressure sensor in drainage line L3, but this is not the case when concentrate-water pressure sensor 16 is installed in drainage line L3 as illustrated. In other words, the occurrence of RO membrane biofouling leads to blockage of the flow path of raw water and in turn to an increase in pressure drop, as described above, and thus also appears as an increase in the differential pressure (i.e. the difference between the supply pressure of raw water and the outflow pressure of concentrate water). Therefore, if the differential pressure of the RO membrane can be detected by raw-water pressure sensor 14 and concentrate-water pressure sensor 16, the detected value may be used to calculate the contamination level of the RO membrane. This third calculation method is advantageous in that since the differential pressure of the RO membrane is hardly affected by water temperature fluctuations, its influence does not need to be taken into consideration when the contamination level of the RO membrane is calculated.

As such, in the third calculation method, when the current differential pressure of the RO membrane is detected based on the difference between the value detected by raw-water pressure sensor 14 (preferably, its moving average) and the value detected by concentrate-water pressure sensor 16 (preferably, its moving average), the detected value is directly compared with the differential pressure when starting to use the RO membrane (called “initial differential pressure”) stored in control device 30. Then, if the current differential pressure is higher than the initial differential pressure, the difference between them is calculated as the contamination level, and if equal or lower, the contamination level is set to zero. The initial differential pressure is preferably one obtained after a certain period has elapsed since the RO membrane was first used and its performance has stabilized, more preferably its moving average. Further, When the third calculation method is implemented, temperature sensor 15 may be omitted and one differential pressure sensor may be provided instead of two pressure sensors 14, 16.

### (Fourth Calculation Method)

The third calculation method is advantageous in that the differential pressure of the RO membrane is hardly affected by water temperature fluctuations, as described above, but the following points should be noted when using this method. In other words, by analogy with the equations expressing the relation between the pressure drop and the flow rate of fluid flowing through a circular pipe (such as Fanning equation and Hagen-Poiseuille equation), the differential pressure of the RO membrane is considered proportional to the nth power (1≤n≤2) of the flow rate of raw water passing through the primary side of the RO membrane (called “primary-side flow rate”). As such, the differential pressure of the RO membrane will change not only when biofouling occurs, but also when the flow rate of concentrate water flowing through drainage line L3 changes and accordingly the primary-side flow rate of raw water changes. Such changes in the flow rate of concentrate water may occur, for example, even when the above-described flow control of concentrate water is implemented for the following reasons: the set flow rate is changed; or the flow rate is less frequently adjusted by manual valve V1 even if the set flow rate is not changed. For that reason, simply using the third calculation method as it is may not accurately estimate how much the differential pressure of the RO membrane increases due to biofouling, whereby the contamination level of the RO membrane may not be accurately calculated.

Therefore, in the fourth calculation method, the contamination level of the RO membrane is calculated based not on the current differential pressure itself of the RO membrane, but on a value obtained by correcting it for changes in the flow rate of concentrate water. Specifically, when the current differential pressure of the RO membrane is detected as in the third calculation method, at the same time, the current flow rate of concentrate water is detected by a flow sensor (not shown) installed in drainage line L3, and preferably a moving average of its detected value is calculated. Then, based on the detected current flow rate of concentrate water and the flow rate of concentrate water when starting to use the RO membrane (called “initial concentrate water flow rate”) stored in control device 30, the current differential pressure is converted into a value at the initial concentrate water flow rate. The differential pressure thus converted is compared with the initial differential pressure, and the contamination level of the RO membrane is calculated as in the third calculation method. Specifically, if the differential pressure converted is higher than the initial differential pressure, the difference between them is calculated as the contamination level, and if equal or lower, the contamination level is set to zero. This calculation method prevents overestimation of how much the differential pressure increases due to biofouling and is expected to further reduce the amount of biocide used.

As a conversion equation for the differential pressure, if the flow of raw water passing through the primary side of the RO membrane is turbulent, Fanning equation (corresponding to the case where the above exponent n is 2) is preferably used, but is not limited thereto. For example, after verifying what flow state the raw water is actually in (i.e. what value of the above exponent n is), the relational equation obtained from the verification may be used to convert the differential pressure. Ideally, the differential pressure is preferably corrected based on the average value of the primary-side flow rate of raw water rather than the flow rate of concentrate water flowing through drainage line L3, but it is practically impossible to measure the average value of the primary-side flow rate of raw water with high accuracy. Further, the flow rate of raw water flowing through water supply line L1 may be used to correct the differential pressure, but in that case, the influence of changes in the flow rate of permeate water flowing through permeate water line L2 must also be taken into consideration. Therefore, as a practical matter, the differential pressure is preferably corrected based on the flow rate of concentrate water flowing through drainage line L2, as described above.

The method of calculating the contamination level of the RO membrane, i.e. the method of evaluating the degree of biofouling, is not limited to calculating how much the raw water pressure or the differential pressure increases due to biofouling as described above. For example, the degree of biofouling may be evaluated by measuring total organic carbon (TOC) concentrations in raw water and concentrate water to continuously monitor the difference between them, or by measuring the numbers of viable bacteria in raw water and concentrate water to continuously monitor the difference between them.

Next, the effects of the present invention will be explained with specific examples.

### Example 1

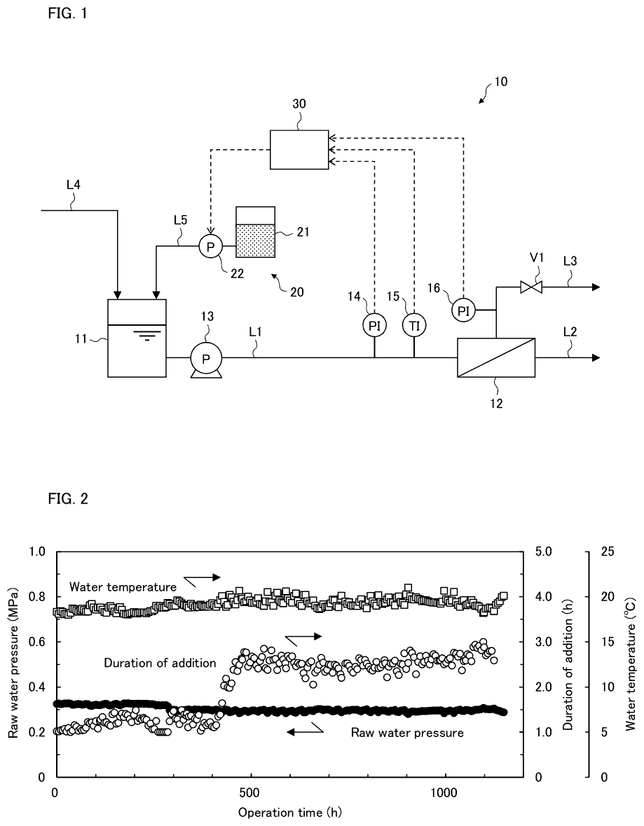

In this example, using a test apparatus simulating the water treatment apparatus shown in FIG. 1, continuous operation was performed while running the biocide addition process once every 24 hours to measure how the raw water pressure (i.e. the supply pressure of raw water supplied to the RO membrane device) changes over time. As raw water, well water that has been subjected to certain pretreatments (disinfection with sodium hypochlorite, solid-liquid separation with a turbidity removal membrane, and dechlorination with activated carbon), to which acetic acid that serves as a nutrient for microorganisms was added at a concentration of 2.5 mg/L, was used. Throughout the operation period, the temperature of the raw water was 17 to 22° C. and the pH thereof was 6.7 to 7.0. The RO membrane used was an RO membrane element manufactured by Nitto Denko Corporation (part number: ESPA2-4040), and the flow controls of permeate water and concentrate water were implemented throughout the operation period to adjust the flow rates of permeate water and concentrate water to 120 L/h and 480 L/h, respectively.

The biocide used was “ORPERSION” (part number: E266) manufactured by Organo Corporation, which is a stabilized hypobromous acid composition containing bromine and a sulfamic acid compound, and the biocide concentration in the raw water in each biocide addition process was fixed at 1.0 mg/L in terms of total chlorine concentration (equivalent to 545 mV in ORP). In the first biocide addition process immediately after starting the operation, the duration of execution thereof (i.e. the minimum duration of addition) was set to 1 hour, so that the amount of biocide to be added (i.e. the minimum amount to be added) was 1 h·mg/L. Then, in the second and subsequent processes, the contamination level of the RO membrane was calculated using the first calculation method, and based on the calculation, the duration of execution of the biocide addition process, i.e. the duration of biocide addition per 24 hours, was changed to adjust the amount of biocide to be added per such process.

### Comparative Example 1

Measurements were performed under the same conditions as in Example 1, except that the duration of execution of each biocide addition process was fixed at 3 hours and the amount of biocide to be added per biocide addition process was adjusted by changing the biocide concentration in the raw water according to the contamination level of the RO membrane. Since this comparative example was carried out at different times than in Example 1, in the first biocide addition process, the biocide concentration in the raw water was set to 0.6 mg/L in terms of total chlorine concentration (equivalent to 530 mV in ORP), so that the minimum amount of biocide to be added was 1.8 h·mg/L.

### Comparative Example 2

Measurements were performed under the same conditions as in Comparative Example 1, except that the biocide concentration in the raw water in each biocide addition process was fixed at 1.0 mg/L in terms of total chlorine concentration without adjusting the amount of biocide to be added according to the contamination level of the RO membrane, and the duration of execution thereof was fixed at 3 hours.

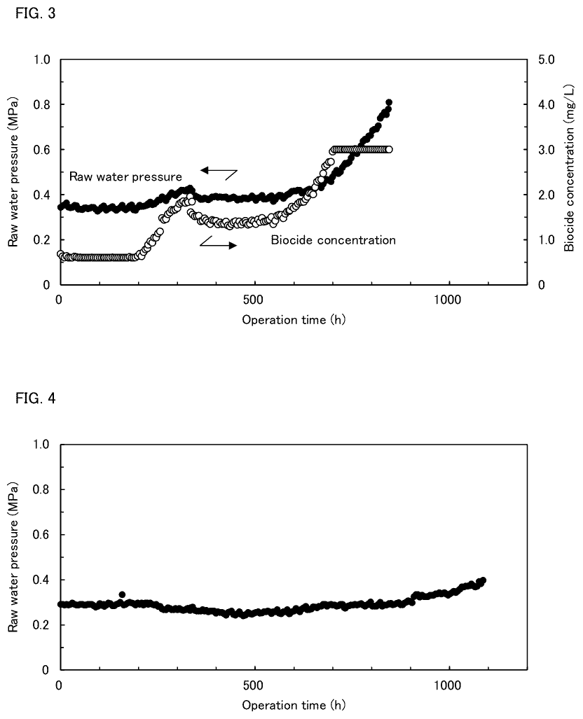

FIGS. 2, 3, and 4 are graphs showing measurement results in Example 1, Comparative Example 1, and Comparative Example 2, respectively. For reference, FIGS. 2 and 3 also show changes in the time-varying parameters (e.g. the duration of biocide addition per 24 hours and the biocide concentration in the raw water), respectively, and FIG. 2 also shows changes in the raw water temperature during the operation period.

As shown in FIG. 2, in Example 1, it was confirmed that the raw water pressure was maintained almost constant throughout the operation period, and that blockage of the RO membrane caused by biofouling was well prevented by adjusting the amount of biocide to be added according to the contamination level of the RO membrane. On the other hand, as shown in FIGS. 3 and 4, in both Comparative Examples 1 and 2, the raw water pressure eventually could no longer be maintained constant. Especially in Comparative Example 1, it was confirmed that after the biocide concentration in the raw water exceeded 2.0 mg/L in terms of total chlorine concentration (equivalent to 570 mV in ORP), the increase in the raw water pressure could no longer be controlled, even though the biocide was added in an amount that appropriately reflects the influence of biofouling as in Example 1. From the analysis of accumulated substances on the RO membrane where the raw water pressure has been increased, it can be inferred that the reason for this is that when the ORP of the raw water containing the biocide increases above a certain level, viscous substances were released from organisms accumulated on the RO membrane surface due to cell wall destruction and excessive stress loading, and the viscous substances blocked the RO membrane.

### Example 2

In this example, using the water treatment apparatus shown in FIG. 1, continuous operation was performed while running the biocide addition process once every 12 hours to investigate how the amount of biocide to be added per such process would change if the contamination level of the RO membrane was calculated using a different method than in Example 1. As raw water, industrial water that has been subjected to certain pretreatments (disinfection with sodium hypochlorite, solid-liquid separation by sand filtration, and dechlorination with sodium hydrogen sulfite) was used. Throughout the operation period, the temperature of the raw water was 20 to 25° C. and the pH thereof was 6.8 to 7.2. The RO membrane device used was an RO membrane module with 40 RO membrane elements (part number: ESPA1) manufactured by Nitto Denko Corporation, and the flow controls of permeate water and concentrate water were implemented throughout the operation period. The set flow rates of permeate water and concentrate water in that case were 35 L/h and 15 L/h, respectively.

The biocide used was the same as in Example 1, and the amount of biocide to be added per biocide addition process was adjusted using the same procedure as in Example 1, except that the contamination level of the RO membrane was calculated using the third calculation method. The biocide concentration in the raw water in each biocide addition process was fixed at 1.0 mg/L in terms of total chlorine concentration, as in Example 1. The duration of execution of the first biocide addition process immediately after starting the operation (i.e. the minimum duration of addition) was set to 15 minutes, so that the amount of biocide to be added (i.e. the minimum amount to be added) was 0.25 h mg/L.

### Example 3

Continuous operation was performed under the same conditions as in Example 2, except that the fourth calculation method was used to calculate the contamination level of the RO membrane.

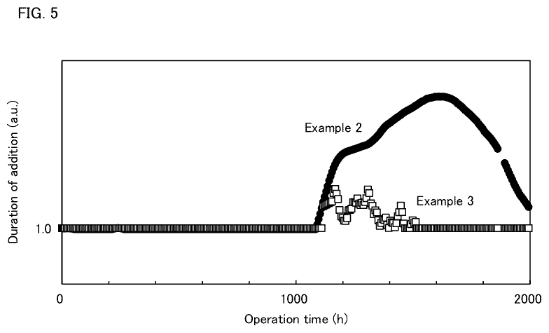

FIG. 5 is a graph showing how the duration of biocide addition per 12 hours changes over time in Examples 2 and 3. The vertical axle in the graph is normalized by the minimum duration of addition.

As is clear from FIG. 5, the amount of increase in the duration of biocide addition is smaller overall in Example 3, where the contamination level of the RO membrane is calculated taking into the changes in the flow rate of concentrate water consideration, compared to Example 2, where the contamination level of the RO membrane is calculated without taking it into consideration. On the other hand, although not shown in detail here, in both Example 2 and 3, no significant increase in the differential pressure (i.e. the difference between the supply pressure of raw water supplied to the RO membrane device and the outflow pressure of concentrate water flowing out of the RO membrane device) was observed throughout the operation period, allowing stable operation to continue. This indicates that both Examples 2 and 3 are good in terms of preventing blockage of the RO membrane, but Example 3 is considered better in terms of reducing the amount of biocide used.

### REFERENCE SIGNS LIST

10 Water treatment apparatus
11 Raw water tank
12 Reverse osmosis (RO) membrane device
13 Pressurizing pump
14 Raw-water pressure sensor
15 Temperature sensor
16 Concentrate-water pressure sensor
20 Biocide addition device
21 Biocide tank
22 Chemical injection pump
30 Control device
L1 Water supply line
L2 Permeate water line
L3 Drainage line
L4 Raw water line
L5 Biocide supply line

1. A water treatment method, comprising:
supplying water to be treated to a reverse osmosis membrane to be separated into permeate water and concentrate water; and
intermittently adding a biocide to water to be treated supplied to the reverse osmosis membrane, the biocide being a bromine-based oxidant, a stabilized hypobromous acid composition containing bromine and a sulfamic acid compound, an iodine-based oxidant, or 2,2-dibromo-3-nitrilopropionamide (DBNPA),
wherein the intermittently adding the biocide comprises:
evaluating a degree of biological contamination of the reverse osmosis membrane; and
adjusting, based on the evaluated degree of biological contamination, an amount of the biocide to be added to the water to be treated per a predetermined period to an extent that an oxidation-reduction potential and/or total chlorine concentration of the water to be treated after adding the biocide does not exceed a preset predetermined value.

2. The water treatment method according to claim 1, wherein the adjusting the amount of the biocide to be added comprises changing a duration of addition of the biocide per the predetermined period according to the evaluated degree of biological contamination, while maintaining a constant concentration of the biocide in the water to be treated.

3. The water treatment method according to claim 2, wherein the evaluating the degree of biological contamination of the reverse osmosis membrane comprises:
detecting a current water temperature of any one of water to be treated supplied to the reverse osmosis membrane, permeate water flowing out of the reverse osmosis membrane, and concentrate water flowing out of the reverse osmosis membrane;
detecting a current supply pressure of water to be treated supplied to the reverse osmosis membrane; and
calculating a contamination level indicating the degree of biological contamination of the reverse osmosis membrane, based on an initial value of the water temperature of the any one that is previously detected when starting to use the reverse osmosis membrane, an initial value of the supply pressure that is previously detected when starting to use the reverse osmosis membrane, the detected current water temperature, and the detected current supply pressure.

4. The water treatment method according to claim 3, wherein the calculating the contamination level comprises converting the initial value of the supply pressure into a value at the detected current water temperature, based on the detected current water temperature and the initial value of the water temperature of the any one, to calculate a difference between the detected current supply pressure and the converted initial value of the supply pressure as the contamination level.

5. The water treatment method according to claim 3, wherein the calculating the contamination level comprises converting the detected current supply pressure and the initial value of the supply pressure into values at a standard temperature, respectively, based on the detected current water temperature and the initial value of the water temperature of the any one, to calculate a difference between the converted current supply pressure and the converted initial value of the supply pressure as the contamination level.

6. The water treatment method according to claim 2, wherein the evaluating the degree of biological contamination of the reverse osmosis membrane comprises:
detecting a current pressure difference between a supply pressure of water to be treated supplied to the reverse osmosis membrane and an outflow pressure of concentrate water flowing out of the reverse osmosis membrane; and
calculating a contamination level indicating the degree of biological contamination of the reverse osmosis membrane, based on the detected current pressure difference and an initial value of the pressure difference that is previously detected when starting to use the reverse osmosis membrane.

7. The water treatment method according to claim 6, wherein the calculating the contamination level comprises calculating a difference between the detected current pressure difference and the initial value of the pressure difference as the contamination level.

8. The water treatment method according to claim 6, wherein the evaluating the degree of biological contamination of the reverse osmosis membrane further comprises detecting a current flow rate of concentrate water flowing out of the reverse osmosis membrane, and
wherein the calculating the contamination level comprises correcting the detected current pressure difference, based on the detected current flow rate and an initial value of the flow rate that is previously detected when starting to use the reverse osmosis membrane, to calculate a difference between the corrected current pressure difference and the initial value of the pressure difference as the contamination level.

9. The water treatment method according to claim 2, wherein the changing the duration of addition comprises setting a value obtained by adding a duration set according to the contamination level to a duration of addition that is preset when starting to use the reverse osmosis membrane as a new duration of addition.

10. The water treatment method according to claim 1, wherein the predetermined value for the oxidation-reduction potential is 570 mV and the predetermined value for the total chlorine concentration is 2.0 mg/L.

11. A water treatment device, comprising:
a reverse osmosis membrane device that separates water to be treated into permeate water and concentrate water;
a biocide addition device that adds a biocide to water to be treated that is to be supplied to the reverse osmosis membrane device, the biocide being a bromine-based oxidant, a stabilized hypobromous acid composition containing bromine and a sulfamic acid compound, an iodine-based oxidant, or 2,2-dibromo-3-nitrilopropionamide (DBNPA); and
a control device that intermittently performs an addition of the biocide by the biocide addition device,
wherein the control device evaluates a degree of biological contamination of the reverse osmosis device, and adjusts, based on the evaluated degree of biological contamination, an amount of the biocide to be added to the water to be treated per a predetermined period to an extent that an oxidation-reduction potential and/or total chlorine concentration of the water to be treated after adding the biocide does not exceed a preset predetermined value.
